(19) United States
(12) Patent Application Publication
(10) Pub. No.: US 2014/0142965 A1
(43) Pub. Date: May 22, 2014

(54) METHOD AND APPARATUS FOR CONNECTING CLINICAL SYSTEMS WITH BEHAVIOR SUPPORT AND TRACKING

(71) Applicants: Thomas K. Houston, Harvard, MA (US); Rajani S. Sadasivam, Shrewsbury, MA (US); Daniel E. Ford, Glen Arm, MD (US); Benjamin M. Marlin, Amherst, MA (US); James Allan, Amherst, MA (US); Erik M. Volz, Ann Arbor, MI (US)

(72) Inventors: Thomas K. Houston, Harvard, MA (US); Rajani S. Sadasivam, Shrewsbury, MA (US); Daniel E. Ford, Glen Arm, MD (US); Benjamin M. Marlin, Amherst, MA (US); James Allan, Amherst, MA (US); Erik M. Volz, Ann Arbor, MI (US)

(21) Appl. No.: 14/055,098

(22) Filed: Oct. 16, 2013

Related U.S. Application Data
(60) Provisional application No. 61/714,426, filed on Oct. 16, 2012.

(51) Int. Cl. G06F 19/00

(52) U.S. Cl. CPC G06F 19/36
USPC 705/2

(57) ABSTRACT

A web-based system and method for implementing a smoking cessation support therapy promotes individual, proactive participation by obtaining an initial consent, indicating motivation, from a patient, and linking the patient with a clinician for monitoring, feedback, and direction of subsequent support media based on clinician oversight and the reported motivation of the patient. The disclosed system encompassing self-motivation assessment, reinforcement feedback, and communication linkages to both clinicians and peers provides for a proactive response by a patient to a clinician invitation, thus establishing a minimal motivational level, and gathers statistical and motivational information from the patient for subsequent monitoring by the clinician

### RELATED APPLICATIONS

This patent application claims the benefit under 35 U.S.C. §119(e) of U.S. Provisional Patent App. No. 61/714,426, filed Oct. 16, 2012, entitled “METHOD AND APPARATUS FOR CONNECTING CLINICAL SYSTEMS WITH BEHAVIOR SUPPORT AND TRACKING,” incorporated herein by reference in entirety.

### STATEMENT OF FEDERALLY SPONSORED RESEARCH

This invention was made with government support under grants no. CA129091, R21CA158968, and K07CA172677 all awarded by the National Cancer Institute of the National Institutes of Health, and grant No. PI-12-001 by the Patient-Centered Outcomes Research Institute. The government has certain rights in the invention.

### BACKGROUND

Smoking cessation and similar habitual, chronic or addictive behaviors have come under scrutiny in recent decades as research associating physical symptoms and psychological trends becomes more refined. Rising medical costs have further underscored the benefits of healthy lifestyles. Treatment of behavior related ailments such as smoking entail both a clinical side and a public health component. Doctors and medical practitioners can document physiological medical conditions and results of smoking. Self-help and public service media provide advertising and Internet-based information and support. However, conventional approaches typically focus only on one of either the clinical side or the public health side. Further, patient self-management interventions for smoking cessation tend to be underutilized because health care providers do not routinely refer smokers to these interventions.

Tobacco use has been cited as the number one behavioral health problem and number one preventable cause of death. Interventions to reduce smoking have most frequently targeted patients. Patient self-management interventions for smoking cessation include mass dissemination of tobacco cessation self-help materials, computer-tailored printouts, interactive voice response systems, and more recently, “quitlines” and smoking cessation websites. Unfortunately, self-management interventions for smoking cessation have been underutilized. Studies of quitlines note that as little as 3.5% of adult smokers call per year. Quality improvement and implementation interventions have tried to change processes of care or provider behavior related to tobacco control with some success. Brief clinical interventions, based on tobacco use screening and brief, structured cessation advice from a provider, have been documented to improve patient cessation rates.

### SUMMARY

An interactive behavior support system for smoking cessation integrates proactively sought support media with clinical feedback from a health care provider (doctor or other clinician) for ensuring patient compliance with cessation measures and decreasing the likelihood of relapse by clinician monitoring and direction of the support media in response to patient reported motivational level. Configurations herein are based, in part, on the observation that conventional support systems for smoking cessation remain separated from a clinical side directed to individual patient response, feedback and proactively sought goals. Conventional telephone based “quit lines” may offer a one-time use or repetitive calls of a supportive nature, but fail to recognize or establish patterns or progress over time. Similarly, interactive websites commonly available on the Internet and other mediums suffer from the shortcoming that patient-clinician integration and oversight is lacking. While conventional multimedia outlets may offer a plethora of information, such approaches do not focus or direct the information based on individual progress of a patient, nor track progress from one visit to the next.

Although healthcare practices have embraced effective strategies, including routine screening for tobacco use, and advice to quit is becoming universal, it has been found that clinicians infrequently refer smokers to publicly available programs for smoking cessation, such as telephone quitlines, automated messaging, and informational websites. Conversely, technology-assisted tobacco interventions have not been engineered to connect with clinical practices and provide post-referral feedback on patient progress. Tobacco control could be more effective in a combined clinical and technology-assisted cessation interventions. However, questions remain about how to best support clinical practices in helping their smokers avail themselves of technology-assisted interventions. Configurations herein present the effectiveness of a clinical practice point-of-care “e-referral” system virtually integrated with a technology-assisted smoking cessation intervention, deployed clinically as a website Decide2Quit.org (D2Q). The e-referral creates both an identity link (patient email) with D2Q, to engage the patient after the clinical visit, and a practice link, providing feedback on each smoker's efforts to quit and allowing providers to use D2Q to securely message their patients. This approach provides a “warm handoff” from clinical encounter to public health (and back), and has been evaluated via a pragmatic randomized trial executed through community-based primary care practices.

Accordingly, configurations herein disclose a web-based system and method for implementing a smoking cessation support therapy by obtaining an initial consent, indicating motivation, from a patient by a clinician, and linking the patient with the clinician for monitoring, feedback, and direction of subsequent support media based on clinician oversight and the reported motivation of the patient, accessed by the patient via a patient interface. The disclosed system encompasses self-motivation assessment, reinforcement feedback, and communication linkages to both clinicians and peers. A clinician interface allows a clinician to monitor a plurality of patients corresponding to the clinician, and provide feedback on an appropriate granularity based on motivation and history.

The disclosed approach substantially overcomes the above-described shortcomings by allowing a proactive response by a patient to a clinician invitation, thus establishing a minimal motivational level, and gathering statistical and motivational information from the patient for subsequent monitoring by the clinician. Supporting studies have shown, as discussed further below, that an affirmative action by a user, rather than an unsolicited urging from a doctor, has a greater likelihood of evoking a positive user response. In other words, treatment is more likely to be effective when a patient actively seeks it, rather than being compelled by a third party to act. Similarly, interactive feedback from a clinician responsive to individual motivation and status, rather than generic statistics and undirected information, leads to a greater chance of program continuation and a lower chance of relapse.

Prior interventions, including telephonic quitlines do not have a direct link to primary care providers. There are currently no websites that have a direct portal for physicians to enter patient e-mail and “e-refer” them to the intervention site. Conventional approaches such as other websites and quitlines offer educational information on quitting, but do not have the ability to send peer-messages by e-mail. Such conventional approaches do not encompass a multi-component approach to tobacco cessation and relapse prevention, and do not provide direct referrals from physicians, or direct feedback to physicians.

The disclosed system includes a series of interactive graphical user interface (GUI) screens responsive to the needs and motivation of a patient, as overseen by the doctor or clinician referring the patient. A motivational status summarizing each patient's progress, as well as patient history with the website, is available to the clinician for directing media content suited to the patient. The website has a series of screens based on the motivational status, coupled with individualized feedback from the clinician. Studies suggest that the individualized messages based on the motivation and history of the patient are better received and less likely to be dismissed as empty or hollow statements.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a login page of the user (patient) side of the system;

FIG. 2 shows a home page of the user side;

FIG. 3 shows an introduction screen;

FIG. 4 shows a risk outline displayed to new users;

FIG. 5 shows an input screen for motivational self-assessment;

FIG. 6 shows a menu of quitting options;

FIG. 7 shows an interface for family support options;

FIG. 8 shows an interface for health care provider options;

FIG. 9 shows an interface for access to a library of support tools;

FIG. 10 shows an interface to web based tools and social media;

FIG. 11 shows a login screen for a health care provider;

FIG. 12 shows an entry for referring a specific patient;

FIG. 13 shows a listing of current patients of the health care provider;

FIG. 14 shows an interface for selecting a motivational message to a particular patient;

FIG. 15 shows an interface for sending the motivational message of FIG. 14;

FIG. 16 shows an interface for health care provider resources; and

FIG. 17 shows an interface for educating the health care provider.

### DETAILED DESCRIPTION

The accompanying figures and discussion teaches an interactive website-based smoking cessation and support system including a GUI interface to a patient and a GUI interface to a clinician, such as a doctor, therapist or counselor. The system is responsive to an identifier for a behavior support resource such as the URL of the website, in which the addictive behavior resource is invokable via the identifier for accessing the website. Ideally, the identifier results from clinician-patient engagement in response to a perceived need for smoking cessation treatment, hence the patient is seeking treatment on their own prerogative, rather than being “nagged” by the clinician. Typically the clinician gives the website URL to a patient who is at least interested in investigating smoking cessation for allowing them to proactively but non-bindingly log on and investigate the website. A common symptom with a compulsive behavior such as smoking is a fear of change or being “locked in” once an affirmative step or proactive measure is pursued. The website allows a noncommittal venture by the patient to investigate the website.

Widely accessible public health resources such as web-assisted tobacco interventions as disclosed herein have the potential to improve smoking cessation rates. Computer-tailored communication systems assess an individual's unique background, needs, interests, and concerns in order to relay a personalized message to motivate behavior change. By directly addressing the specific needs of an individual, the tailored message can be more personally informative and motivating. Tailored messages show promise in helping participants reach behavior change goals, and use of online, tailored, quit-smoking tools is associated with six-month smoking cessation abstinence. Tailored emails can encourage website use are economical, and can cover a broad geographic area.

Although theoretically sound, such tailoring systems may not account for socio-cultural concepts that have intrinsic importance to the targeted population, limiting their relevance to the audience. Developers of tailored or custom response-based feedback may nonetheless fall short of true experiences with the mental and behavioral issues. Expert-written messages may also omit some topics relevant to smokers and may be written in a form or use wording that poorly reflects the real-world experiences of the smokers engaged in the intervention. Messages “in a smoker's own words” may be more persuasive to other smokers because they reflect shared experiences allowing smokers to more easily identify with the message content.

Peer-to-Peer Communication is increasingly recognized as an important form of persuasive communication. Recent interventions have used patient storytelling, or narrative communication effectively to motivate behavior change. Importantly, peer-to-peer communication does map to important constructs within the Social Cognitive Theory (SCT, i.e.: role modeling). SCT argues individual's social and physical environments, observational learning (i.e.: role modeling), and behavioral capability (i.e., skills) can influence behavioral change. Peer-to-Peer communication can exemplify all of these factors by illustrating the difficulties, skills and strategies needed for smoking cessation. Peer-to-Peer communication also enhances homophily, a feeling of similarity between the message writer and the message reader. In other words, behavioral ideas and recommendations are more likely to be well received from someone perceived as similarly situated, such as one experiencing the same compulsive conflicts.

The configurations disclosed herein depict a system and method for implementing a smoking cessation support therapy by providing an identifier (i.e. username) for a smoking cessation resource, or system, such that the smoking cessation resource is invokable via the identifier, and receiving a patient status indicative of a motivation level of the patient. The self-reported patient status allows the patient to maintain a sense of control and not feel that they are being pressured or compelled to participate—that it is entirely the patient's free will acting on the decision. The system generates support media based on the received motivation level, and periodically reassesses the motivation level and modifies the generated support media in response thereto. Generation of the support media relies on determining a demographic profile of the patient, and matching the patient to positive feedback based on the demographic profile.

Disclosed herein, therefore, is a set of web services, implemented experimentally via a website (decide2quit.org, or D2Q), defining an ordered framework to assist providers in guiding their patients to quit smoking. There are several components of this intervention that are distinguishing from conventional approaches. One component is that our system is the first e-referral system that pro-actively links providers to patients and an available intervention. Doctors and/or their office staff can access a portal through which they can easily refer a patient to the decide2quit.org website by simply entering the patient's e-mail address. Once the e-mail is entered, the patients receive an initial message from their provider with particular content that the provider feels appropriate. Physicians can monitor the engagement of patients they referred on a dashboard style interface within the referral system. Then the system can follow-up with reminder messages to the patient encouraging them to come to the site and register. By utilizing tailored messages and the opportunity for providers to securely message patients, the system is providing a direct, pro-active referral to smoking cessation support. Once a patient has been proactively referred to the smoking cessation website, they are provided comprehensive support via the website. The website provides interactive education on smoking cessation, access to secure messages, tailored messages from peers and experts, and links to other helpful smoking cessation websites. Because the messages are tailored, and the communication from their doctor can be uniquely supportive of endeavors to quit, all smokers can benefit from visiting the site, regardless of their readiness to quit/quit status. An additional component to the website is the availability of patients to communicate with a Tobacco Treatment Specialist (TTS). This is a secure, asynchronous communication path unique to the disclosed system. Configurations herein present novel approaches by breaking ground in providing comprehensive support for smokers in their quest to quit.

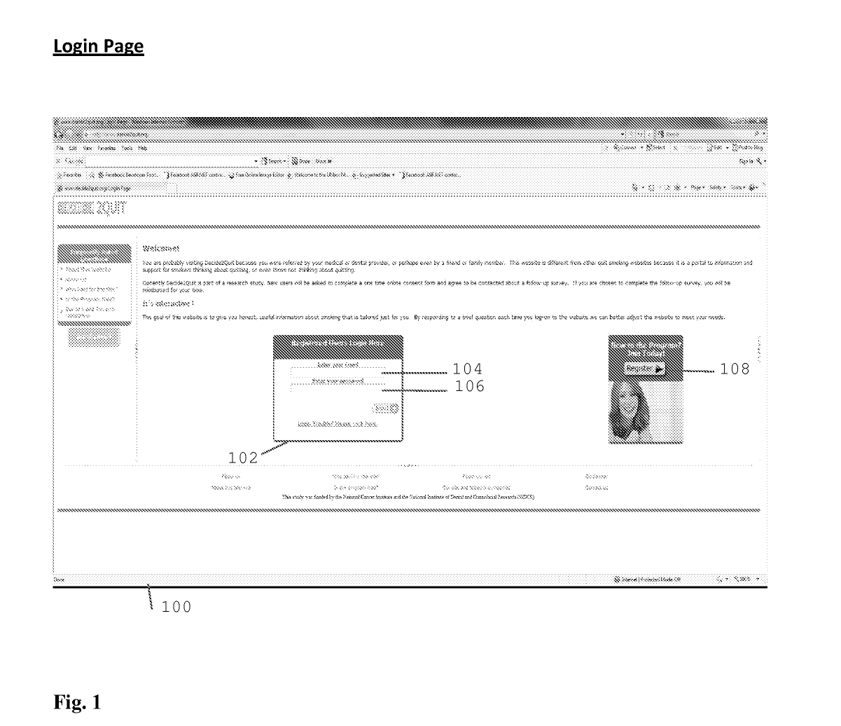

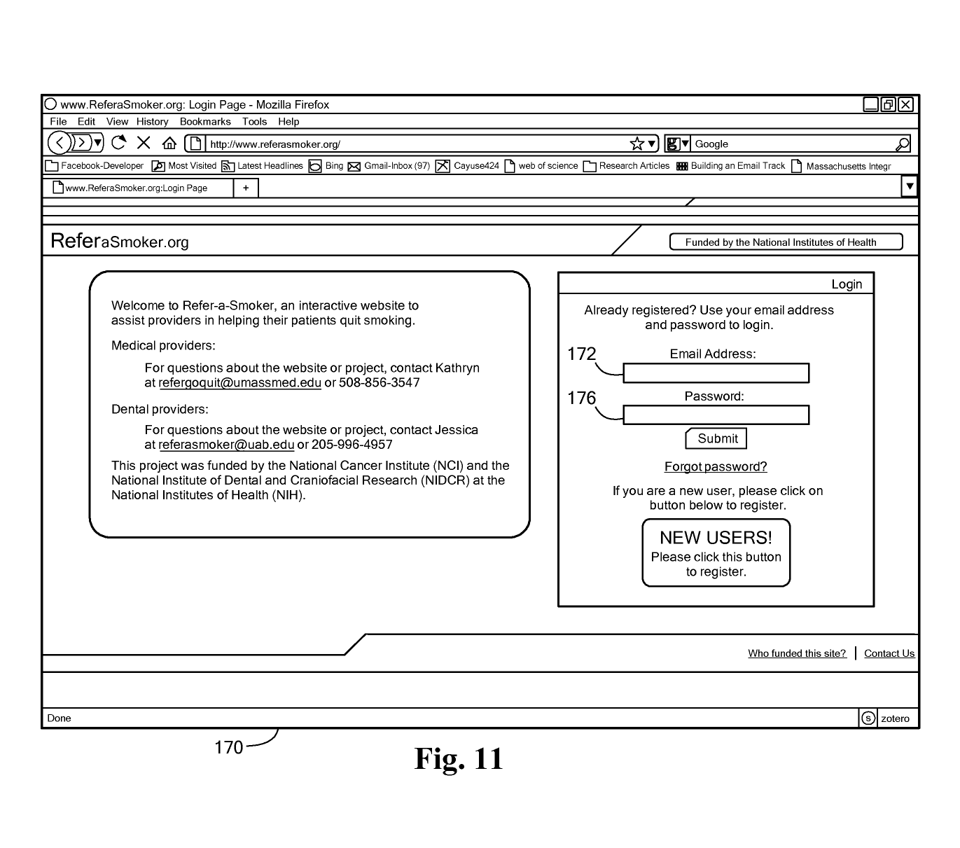

The description and figures below depict the user experience with the website and describe the features of the website. In general, FIGS. 1-10 show a patient side of the user interface, and FIGS. 11-17 show a clinician side of the user interface. FIG. 1 shows a login page of the user (patient) side of the system. Referring to FIG. 1, an intro splash screen 100 includes a login window 102. The login window 102 has a username box 104 and a password box 106, typical for online access. Username is requested as an email, however any suitable identifier may be employed in alternate configurations for distinguishing individual users (patients). A start button 108 validates the username and password, otherwise a register button 109 invites new users to join by entering registration information.

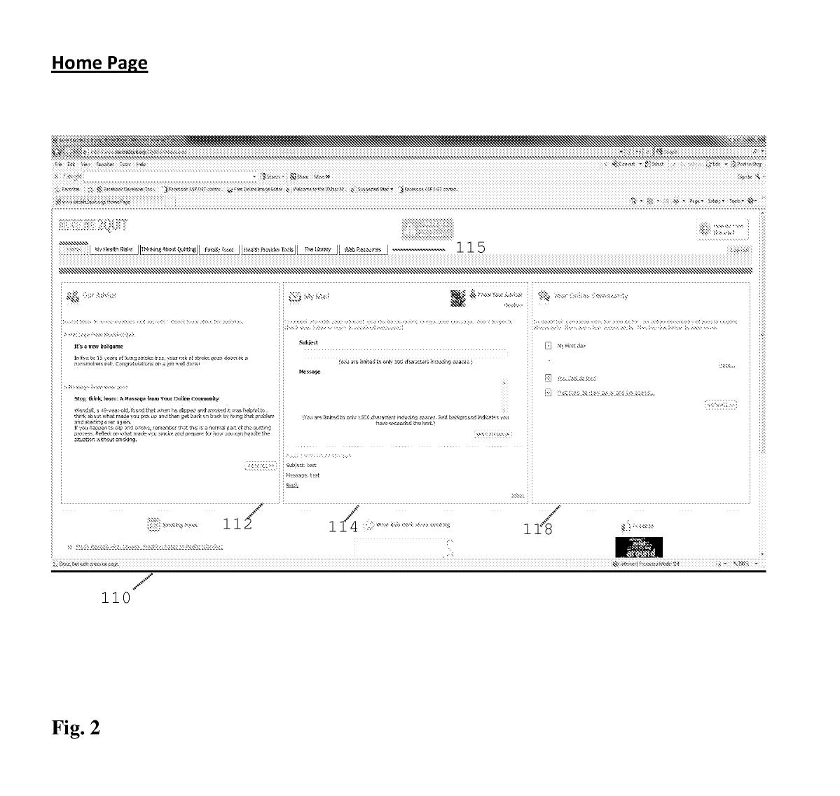

FIG. 2 shows a home page 110 of the user (patient) side. Referring to FIG. 2, an announcement box 112 displays system-wide announcements and motivational or inspirational messages to all users. Selection buttons 115 allow the patient to select from among the menu offerings, detailed in the following pages. A message box 114 allows individual messages between the patient and clinician, using a message entry box 116 and corresponding subject and message fields. A community communications box 118 renders messages in a bulletin board or “chat room” form, where patients may leave messages for perusal by other patients. Interaction and motivational messaging between patients, rather than publicized announcements promulgating anti-smoking media, are deemed to be better received by patients since they will likely identify will with other patients. In particular configuration, the message box integrates with other users such as FACEBOOK® groups, for enhancing communication between similarly-minded patients.

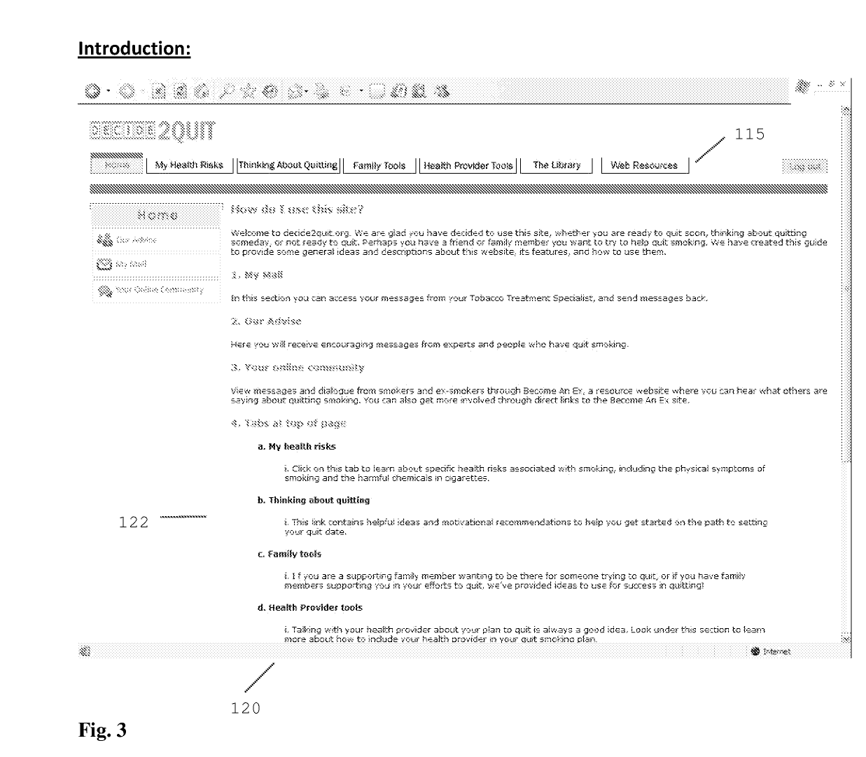

FIG. 3 shows an introduction screen. Referring to FIG. 3, the introduction screen 120 includes instructions and information 122 about navigation and format. While primarily intended for new patients, existing patients may wish to refer to it from time to time.

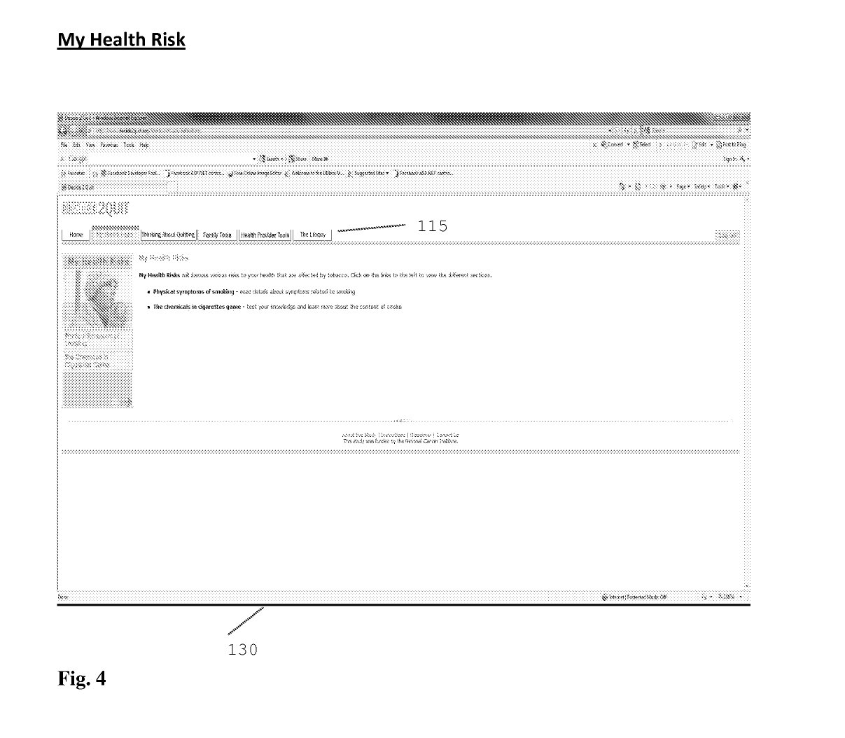

FIG. 4 shows a risk outline displayed to new users. Referring to FIG. 4, a health risk screen 130 allows selection of individual risk topics. The active selection by the patient, rather than passively rendering blanket statements that risk intimidating, annoying, or de-motivating the patient, allows the patient to seek an appropriate level of feedback from the system.

The self-motivation aspect stems from research into enhancing patient-centered health communication, depicted here in the context of the highly significant public health challenge of smoking cessation. Smoking is the number one preventable cause of premature death in the United States, and estimated medical costs of treating smokers are more than US$96 billion a year. Novel patient-centered methods to support an individual's decision to quit smoking are greatly needed.

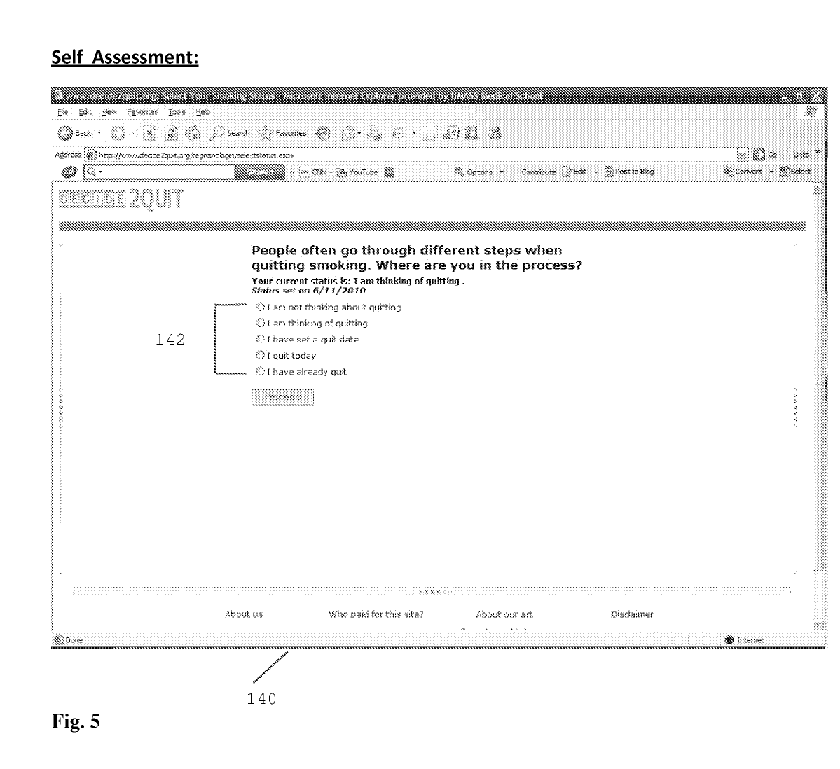

FIG. 5 shows an input screen for motivational self-assessment. Referring to FIG. 5, the self assessment screen 140 presents a button list 142 of self-assessment levels. Active user selection allows the patient control in determining the level of intervention to expect from the system. In other words, the patient can elect “not thinking about quitting” if they are not receptive to dissuasion. In this manner, the system can avoid being shut out by the user by offering an option to defer, rather than alienating a patient who has not self-assessed a need for intervention.

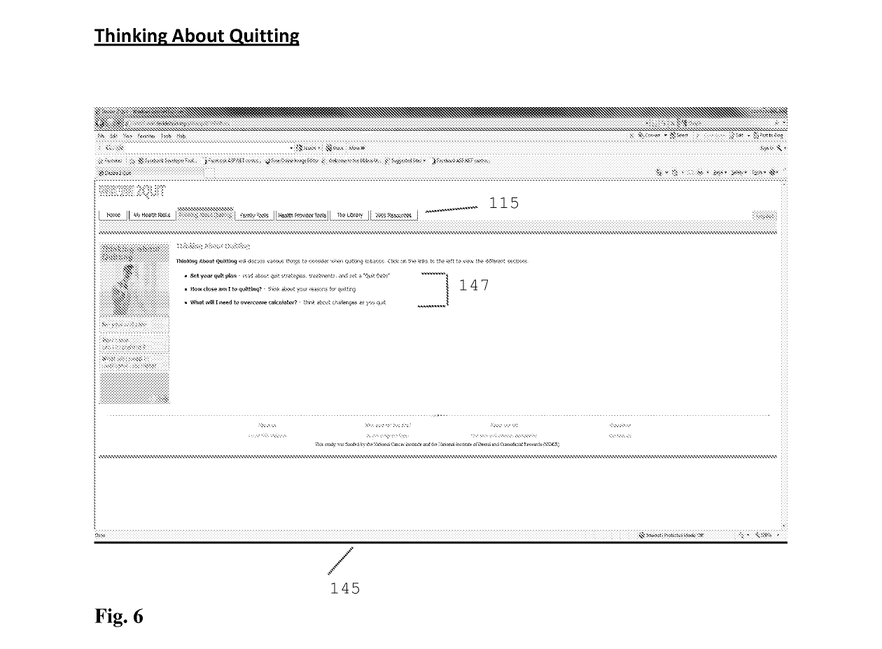

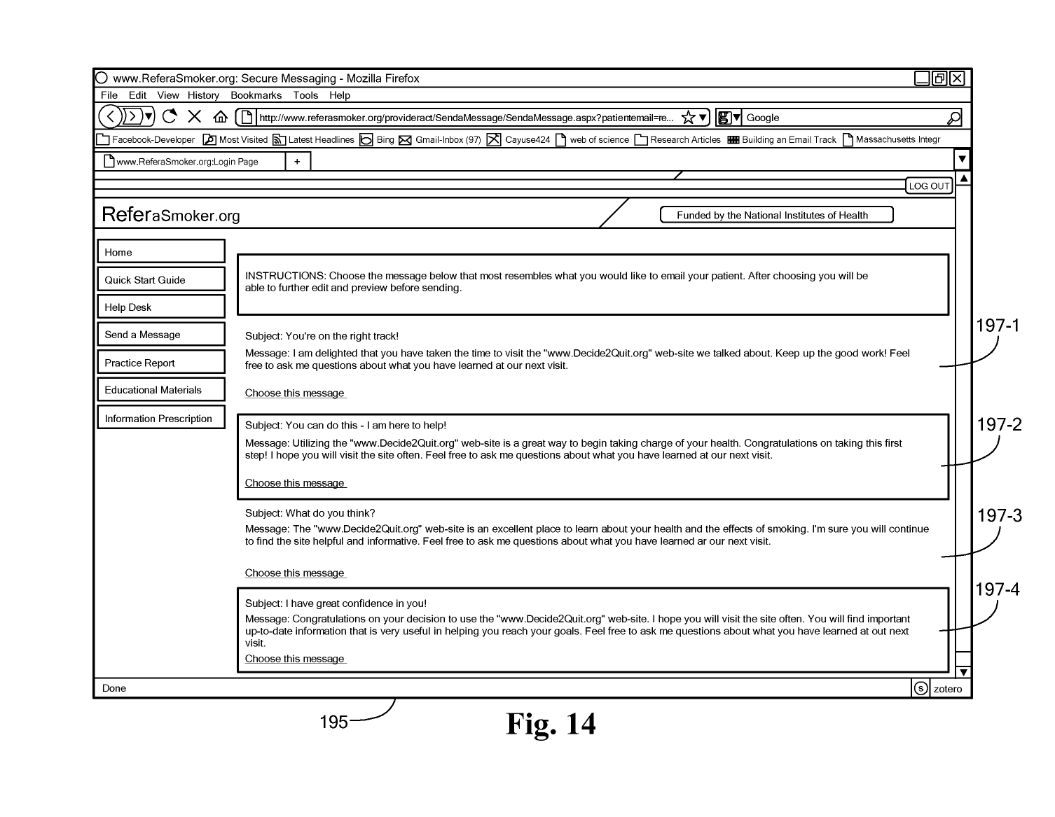

The website receives a patient status indicative of a motivation level of the patient, as shown in FIG. 5, and progresses to a series of screens based on the motivational level entered. The system generates support media based on the received motivation level, as shown in FIG. 6, and periodically reassesses the motivation level and modifies the generated support media in response thereto. On the clinician side, the system receiving clinician input from a health care professional, as shown in FIG. 14, such that the generated support media is further based on the clinician input. For example, the interface of FIG. 14 below allows customized reinforcement feedback to be selected from predetermined messages or entered individually as free-form text.

FIG. 6 shows a menu of quitting options. Referring to FIG. 6, a quitting options screen 145 displays a set of menu options 147 for empowering the patient to select options of varying degrees of intensity and/or invasiveness. By allowing the patient to select their own level of intensity, the chance of relapse is lessened.

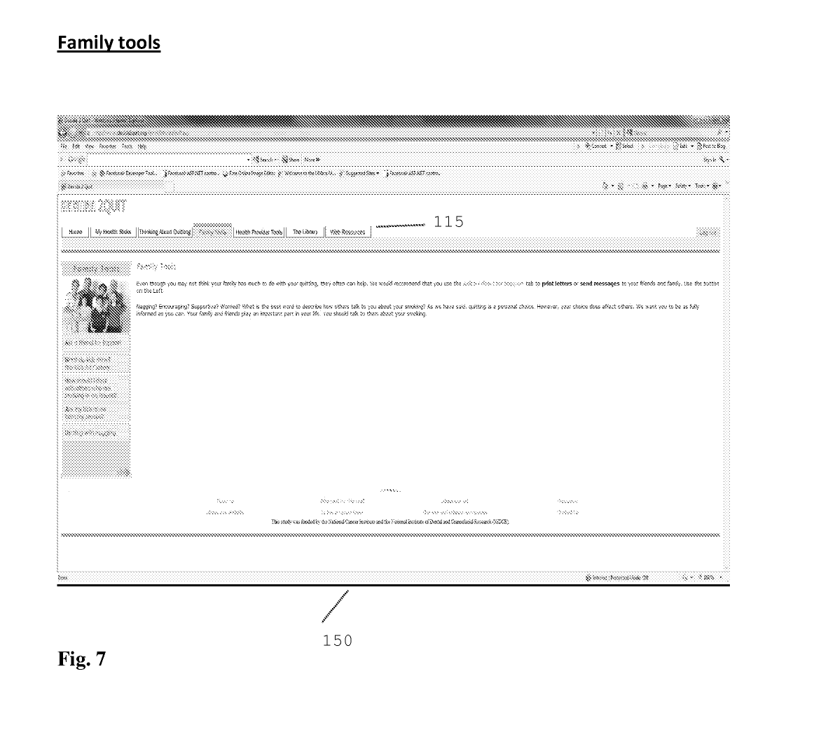

FIG. 7 shows an interface for family support options. Referring to FIG. 7, a family tools screen 150 displays information about seeking support from family members. One aspect of the disclosed approach is the support system provided by continued encouragement from family members and reinforcement and identification with peers.

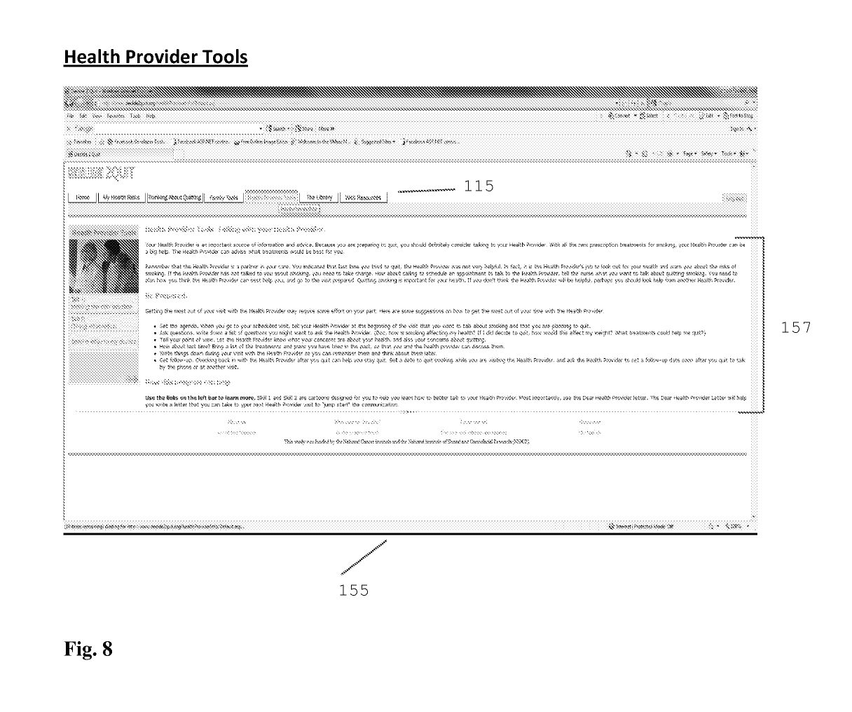

FIG. 8 shows an interface for health care provider options. Referring to FIG. 8, a health provider tools screen 155. Health care providers may offer incentives and/or guidance about behavioral support for quitting. Various selections 157 depict the available options. In particular configurations, this screen 155 may map to an insurance carrier for the patient and display insurance specific options, as well as a portal to the insurance carrier's website.

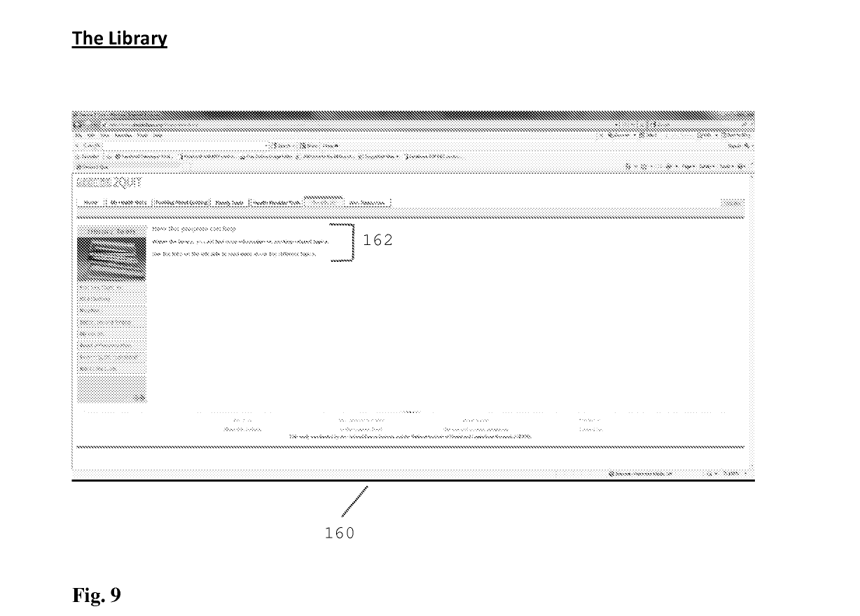

FIG. 9 shows an interface for access to a library of support tools. The library interface screen 160 shows a list 162 of media items (such as literary and video mediums) of available offerings.

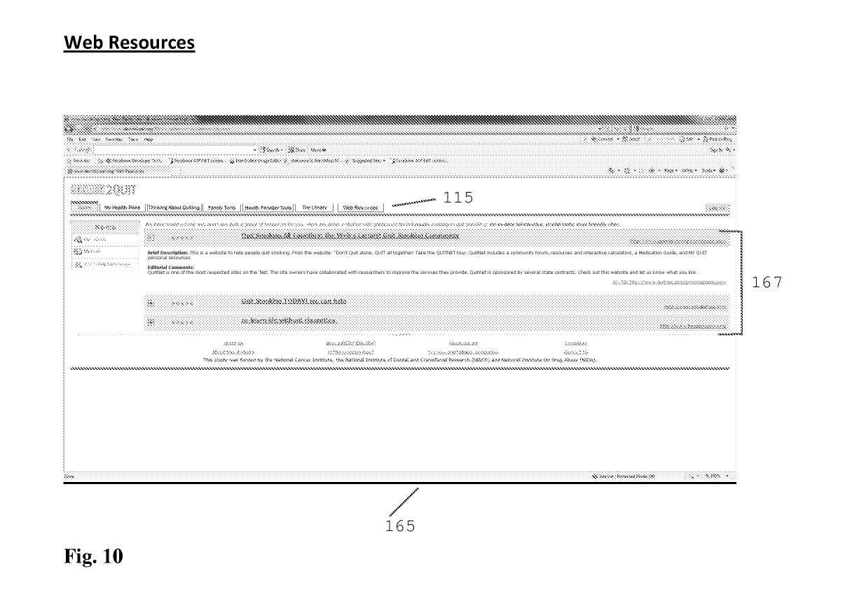

FIG. 10 shows an interface to web based tools and social media. The web resources screen 165 of FIG. 10 includes hyperlinks 167 to other sites offering information and support. In particular configurations, a portal to social networking sites, such as a groups focusing on quitting, compulsive, or addictive behavior is available. The support medium may therefore include social networking mediums, enabling the patient to identify other patients via the social networking medium, and invoke an interface for feedback exchange via the social networking medium. For example, a portal to a FACEBOOK® group may link patients together, typically of a more similar demographic than through age or gender alone. The patient may also invoke a peer interface, separate from or part of the social networking medium, for exchanging feedback with a peer, the peer having a similar behavior change motivation as the patient.

FIG. 11 shows a login screen for a health care provider. The smoking cessation resource (system) employs both an interactive patient interface and an interactive clinician interface, and optionally a peer interface. Patients therefore receive support from clinicians, peers and family, in contrast to conventional approaches which tend to passively provide educational media (i.e. written forms). The health care provider screen is the home page for a doctor or clinician to log in to engage and follow up with a plurality of patients under their care. As with the patient login, a username 172 and password 174 box identify the clinician/provider and permit access.

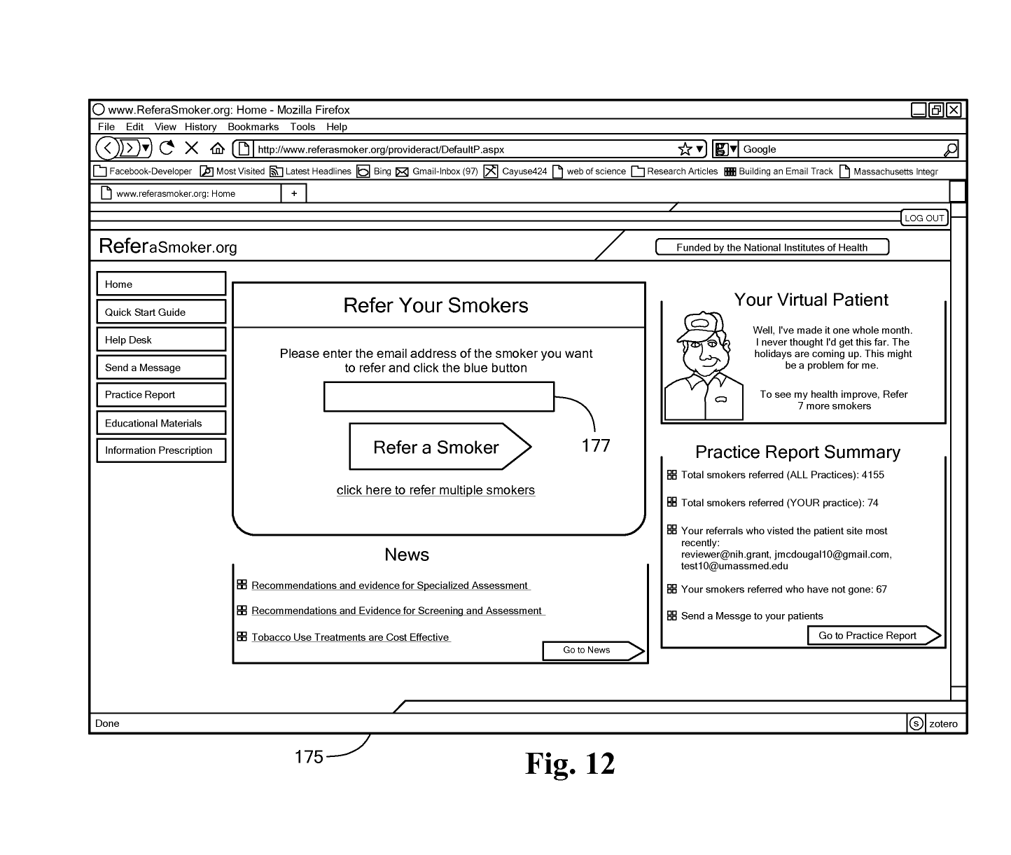

FIG. 12 shows an entry for referring a specific patient. The referral screen 175 provides an interface for the clinician to refer and introduce a new patient to the system. Each patient in the system has a clinician overseeing and monitoring their case. Each patient is initially referred to the system by a clinician, and the patient is expected to take the affirmative step of engaging (logging into) the system. By referring the patient in a referral box 177, the clinician creates the ability for the patient to engage and use the system. The patient also receives a welcome email inviting them to visit the site (system), however the decision to engage and login is left to the patient.

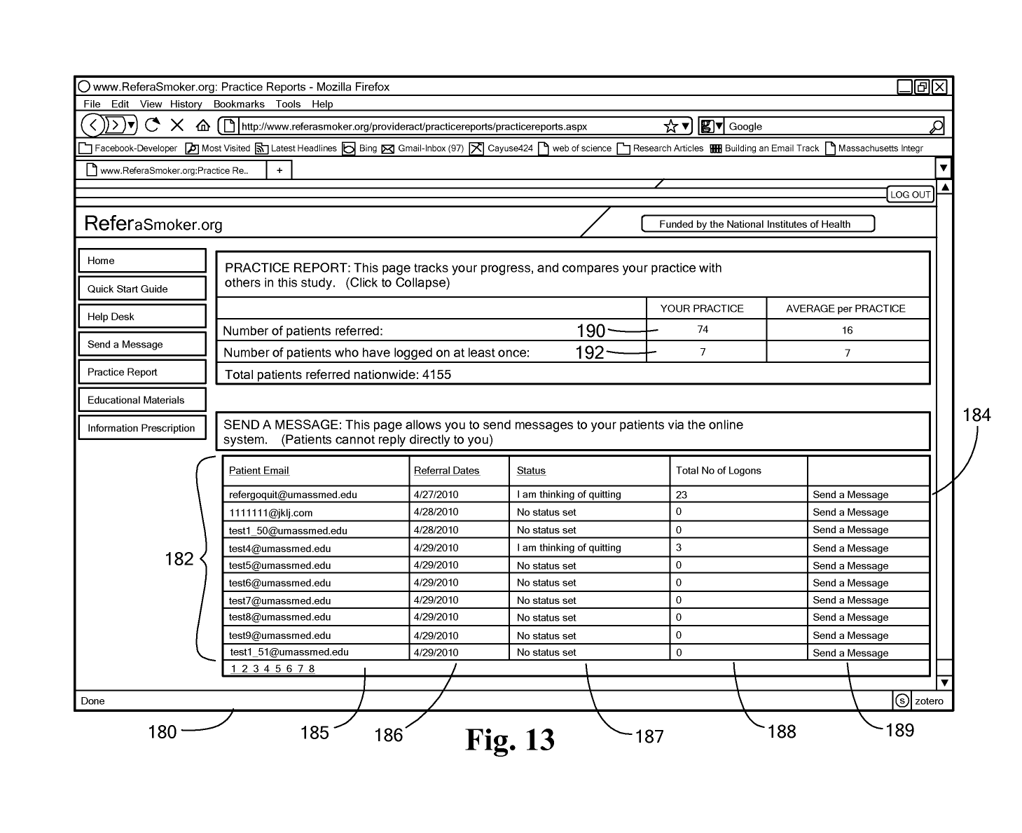

The system further comprises receiving clinician input from a health care professional, such that the generated support media is based on the clinician input. Referring to FIG. 13, the clinician periodically reassesses the motivation level and modifies the generated support media in response thereto, using the current status of each of the patients and login information to assess the patient's level of satisfaction with the system. Using the motivational status, the clinician may send messages to patients of a particular status, thus sending different feedback to patients who have just quit and to those who are still thinking about quitting. Feedback and motivational messages may also be sent to all patients of the clinician or to individual patients by selection on the “send a message” window.

FIG. 13 shows a listing of current patients of the health care provider. Each clinician oversees and/or is assigned to one or more patients. Referring to FIGS. 12 and 13, in a patient practice screen 180, each clinician has a set of patients 182 which they have referred, as in FIG. 12, or are otherwise responsible for (possible by referrals or transfers from other clinicians in the system). Each patient has an entry 184, which displays the email contact 185 for the patient, the referral date 186, as in FIG. 12, a current patient status 187, a number of logons 188 to the system, and a button 189 for sending an inspirational message, discussed further in successive screens below. A total count of patients referred 190 is also shown, indicating the number of patients entered in FIG. 12 for receiving an invitation to explore and consider the system. A visitor count 192 indicates the number of referred patients 190 who have responded to the invitation and visited at least once. The counts 188, 192 and status 187 field offer an indication of how the patients perceive the system, since there is not a compulsive or nagging communication or instruction to use the system; rather only the initial invitation sent from referral box 177 of FIG. 12.

Integration between the patient and clinician is facilitated because the smoking cessation website employs an interactive patient interface and an interactive clinician interface. Accordingly, the identifier for accessing the system may be a URL to a website, and a corresponding username/password, in which the website provides the multimedia rendering medium and the website requests proactive confirmation from the patient. In this manner, the smoking cessation resource embodied in the website integrates clinical input with a support medium to generate clinician driven support media, such that the support medium is monitored by the clinician for directing the support media to the patient. In the example shown herein, the support medium is in the form of a website for providing a remote multimedia transport and rendering system adapted for individual interfacing by a plurality of clinicians and a plurality of patients, such that each patient corresponds to at least one of the clinicians. Alternatively, other private networks and/or rendering mediums may be employed, and treatment for other than smoking may be provided.

FIG. 14 shows an interface for selecting a motivational message to a particular patient. Referring to FIGS. 13 and 14, the send message button 189 defers control to a message selection screen 195. A plurality of available messages 197-1 . . . 197-4 (197 generally) are displayed for review and selection. As indicate above, the available messages may be selected based on demographic information such as age and gender of the patient, and may also be generated by adaptive recognition of messages having a positive effect on other patients.

Generation of the support media, such as the motivational messages, includes receiving reports of patient response to generated feedback response messages, and determining feedback response messages that have had a positive impact on other patients. The system tailors the feedback responses based on a high indication of positive impact on other patients. Such analysis may include identifying groups of patients for which a feedback message was persuasive, and directing the feedback message to other patients in the identified group based on adaptive recognition of the persuasiveness of the feedback message.

To maximize patient perspective and effectively support lifestyle choices, the message selection invokes a Patient Experience Recommender System for Persuasive Communication Tailoring (PERSPeCT). This capability includes is an adaptive computer system that will assess a patient's individual perspective, understand the patient's preferences for health messages, and provide personalized, persuasive health communication relevant to the individual patient. The system proposes to overcome key weaknesses in existing top-down expert-driven health communication interventions by applying advanced machine learning algorithms to adaptively recommend messages based on the “collective intelligence” 1 of thousands of patients. This work will leverage a paradigm-shifting approach to adaptive personalization with the potential for broad impact on the field of computer tailored health communication (CTHC).

Using knowledge from scientific experts, current CTHC interventions collect baseline patient “profiles” and then use expert-written, rule-based systems to target messages to subsets of patients. These market segmentation interventions show some promise in helping certain patients reach lifestyle goals. Although theoretically sound, rule-based systems may not account for socio-cultural concepts that have intrinsic importance to the targeted population, thus limiting their relevance. Further, the rules do not adapt to patient feedback.

Outside healthcare, well known Internet commerce and search companies have made extensive use of adaptive recommendation systems to provide content with enhanced personal relevance. These systems use machine learning algorithms to derive personalized recommendations from a variety of data sources including preference feedback collected from individual users.

This invocation of Computer Tailored Health Communication (CTHC) recognizes that the delivery of general health communication materials (brochures, pamphlets) has limited effect, as the communication may contain information that is not applicable to an individual's psychological state, behavior, or situation. Further, an industry recognized Elaboration Likelihood Model (ELM) suggests that behavioral change is a result of personalization. In CTHC, messages are targeted to patient characteristics. CTHC systems use theory-driven rules to provide different messages to subsets of patients. This market segmentation removes superfluous material, hopefully providing more relevant information. CTHC systems have been marginally effective in triggering behavior changes across health domains. For example, in a review of ten published trials of CTHC for smoking cessation, six showed significantly higher cessation rates than comparison groups.

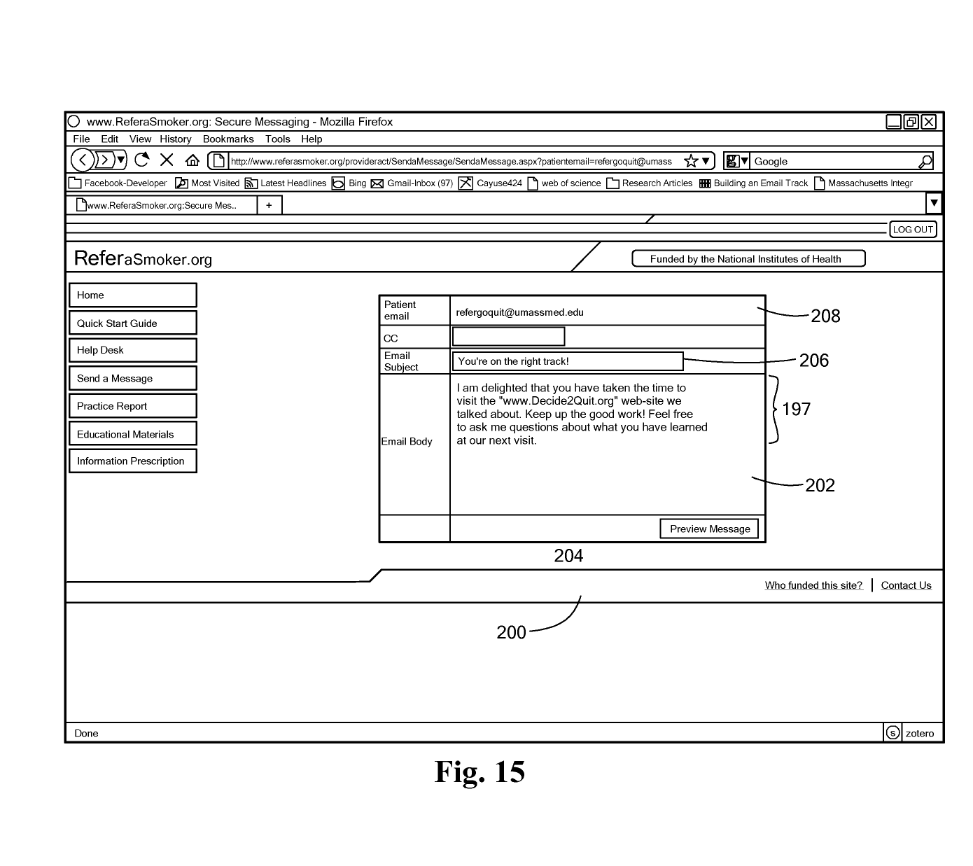

FIG. 15 shows an interface for sending the motivational message of FIG. 14. Referring to FIGS. 13-15, a motivational messaging screen 200 includes the selected message 197 in an email staging box 202, having the message 197 as the email body. A subject entry 206 may be a part of the selected message 197, or separately entered by the clinician. The patient email 208 is populated from the selected patient record 184 from FIG. 13.

Motivational messages are intended to be a significant aspect of the patient support system, by providing positive feedback that reinforces the proactive and self-motivated efforts of the patient. The use of Computer Tailored Health Communication (CTHC) employs behavioral theory constructs to target messages to patient subsets. CTHC have shown to be effective in improving cessation rates. Tailoring works because personally relevant messages are more thoughtfully processed, tend to be retained longer, and are more likely to lead to permanent attitude changes. Technology is the enabling factor in the emergence of tailored health communication. CTHC systems are available over a broad geographic area and deliver tailored messages via multiple platforms, including websites, email, or text messaging.

Outside healthcare, collective intelligence algorithms continually learn and adapt both from the user's behavior and the user community to produce novel insights about the user's needs. Web services on established websites have demonstrated that these algorithms are superior to rule-based tailoring in enhancing personal relevance and increasing user engagement. In conventional systems, however, these algorithms have not been applied to improve upon CTHC systems, for example in behavioral based therapy as disclosed herein. Adapting such collective intelligence algorithms for CTHC benefits stems from the development of a special class of machine-learning algorithms called recommender systems. Recommender systems combine content filtering (e.g. retrieving messages by linking content with patient profiles) and collaborative filtering, using the behavior of thousands of users to maximize personalization. Collaborative filtering systems can use implicit ratings (e.g. return web visits after receiving motivational messages) and explicit user ratings (e.g. “like it” or “thumbs up”). For implementation, it is particularly beneficial to develop comprehensive behavioral codes (metadata) around motivational email messages for content filtering and also for implicit ratings for collaborative filtering.

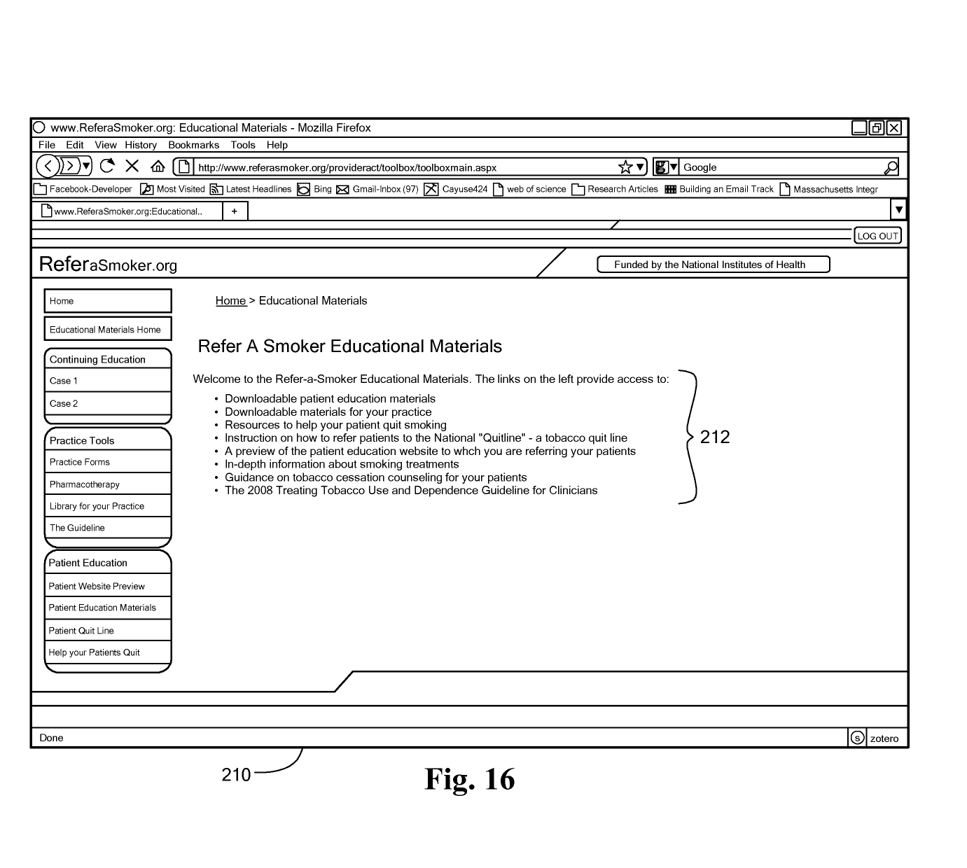

FIG. 16 shows an interface for health care provider resources. Referring to FIG. 16, a clinician offerings screen provides 210 a portal for the health care provider to list additional offerings 212 and vehicles for educational materials and opportunities to disseminate materials to the clinician, who may be affiliated with the health care provider as an employee or consultant.

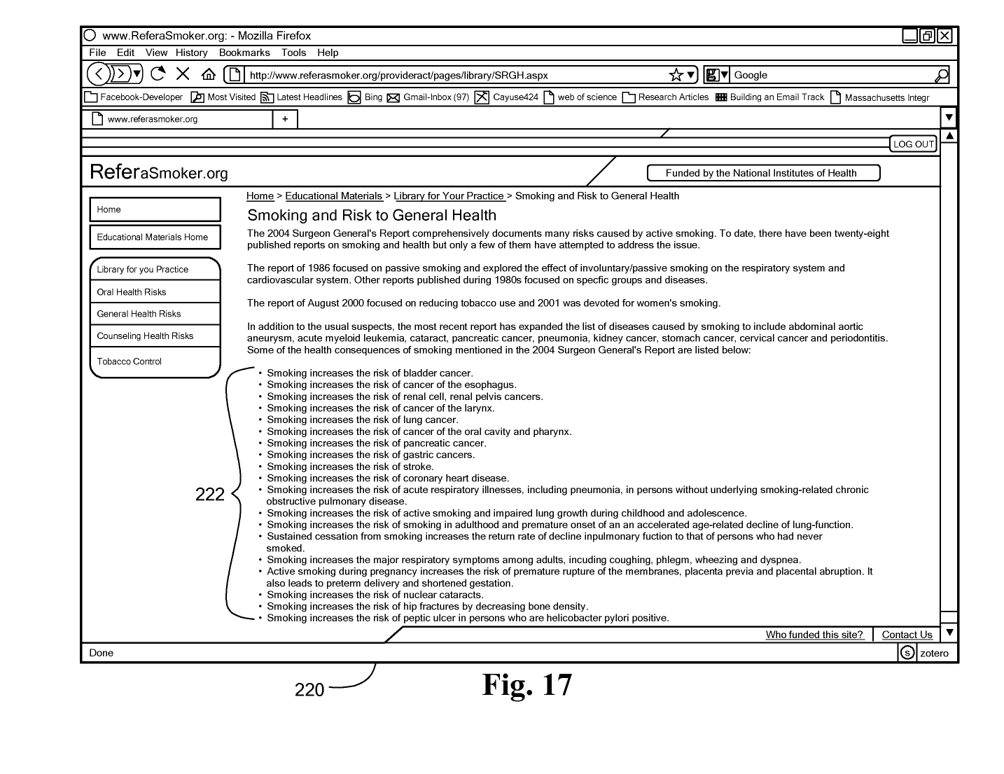

FIG. 17 shows an interface for educating the health care provider. Referring to FIGS. 16 and 17, FIG. 17 includes a health provider offerings screen 220 for listing offerings 222 similar to those in FIG. 16, but of a more general and policy based level that may be more directed to health care companies, rather than individual clinicians.

The approach disclosed below presents features not available in conventional approaches. Conventional patient sites rarely provide secure messaging access to Tobacco Treatment Specialists. Prior sites do not have pushed email motivational messages. Prior sites focus on a smoker that is ready to quit, but do not provide anything for the smoker who is not quite ready to quit—little or no content to encourage or “induce cessation” and conventional websites are stand alone and not integrated with clinical care.

Features provided by the disclosed approach, presented in an example form as websites entitled “Decide2Quit.org,” (for the patient side) and “referasmoker.org” (for the clinical side) exhibit features not previously provided as an integrated smoking cessation program. The disclosed approach provides a Tobacco Treatment Specialist (TTS) portal—where smokers can message with an expert for individualized help. Decide2Quit.org has innovative pushed email messages created by experts, and by smokers for smokers. Pushed (by the clinician), rather than “pulled” email messages and the site in general has content created by peers (smokers for smokers). Content developed within the website serves to motivate smokers with cessation induction, to help smokers THINK about quitting; not just to aid cessation (helping those who have quit). The website includes a provider portal (ReferaSmoker.org) for providing integrated clinical care

Commercial usage of the disclosed website and corresponding research may be used for providing metrics for insurers. One example is that Johns Hopkins Health Insurance for employees is considering a penalty (increased copay) for smokers. Smokers can get this penalty back (refund) if they demonstrate that they are actively involved in planning to quit. The disclosed system and website serves to operationalize this planning to quit, give a certificate. Either the Johns Hopkins Medical System, or individual employees could pay for this, and get their copay back.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

1. A method for implementing a smoking cessation support therapy comprising:
providing an identifier for a smoking cessation resource, the smoking cessation resource invokable via the identifier;
receiving a patient status indicative of a motivation level of the patient;
generating support media based on the received motivation level; and
periodically reassessing the motivation level and modifying the generated support media in response thereto.

2. The method of claim 1 further comprising receiving clinician input from a health care professional, the generated support media further based on the clinician input.

3. The method of claim 2 wherein the provided identifier results from clinician-patient engagement in response to a perceived need for smoking cessation treatment.

4. The method of claim 2 wherein generating the support media further comprises:
determining a demographic profile of the patient; and
matching the patient to positive feedback based on the demographic profile.

5. The method of claim 4 wherein generating the support media further comprises:
receiving reports of patient response to generated feedback response messages;
determining feedback response messages that have had a positive impact on other patients; and
tailoring the feedback responses based on a high indication of positive impact on other patients.

6. The method of claim 5 further comprising:
identifying groups of patients for which a feedback message was persuasive; and
directing the feedback message to other patients in the identified group based on adaptive recognition of the persuasiveness of the feedback message.

7. The method of claim 1 wherein the smoking cessation resource integrates clinical input with a support medium to generate clinician driven support media, the support medium monitored by the clinician for directing the support media to the patient.

8. The method of claim 7 wherein smoking cessation resource employs an interactive patient interface and an interactive clinician interface.

9. The method of claim 7 wherein the support medium is a remote multimedia transport and rendering system adapted for individual interfacing by a plurality of clinicians and a plurality of patients, each patient corresponding to at least one of the clinicians.

10. The method of claim 7 wherein the support medium includes social networking mediums, further comprising:
identifying other patients via the social networking medium; and
invoking an interface for feedback exchange via the social networking medium.

11. The method of claim 7 wherein the identifier is a URL to a website, the website providing the multimedia rendering medium and the website requests proactive confirmation from the patient.

12. The method of claim 11 further comprising invoking a peer interface for exchanging feedback with a peer, the peer having a similar behavior change motivation as the patient.

13. An interactive behavior change support system comprising
a server;
an remote interface to a patient; and
a remote interface to a clinician,
the server responsive to an identifier for an addictive behavior resource, the addictive behavior resource invokable via the identifier for:
receiving a patient status indicative of a motivation level of the patient;
generating support media based on the received motivation level;
periodically reassessing the motivation level and modifying the generated support media in response thereto; and
receiving clinician input from a health care professional, the generated support media further based on the clinician input.

14. The system of claim 13 wherein the identifier results from clinician-patient engagement in response to a perceived need for smoking cessation treatment.

15. The system of claim 13 wherein the generated support media is computed based on:
a demographic profile of the patient; and
a matching of the patient to positive feedback based on the demographic profile.

16. The system of claim 13 wherein the generated support media is computed based on:
reports of patient response to generated feedback response messages;
feedback response messages that have had a positive impact on other patients as determined from adaptive recognition of the persuasiveness of the feedback message.

17. The system of claim 13 wherein the smoking cessation resource is configured for integrating clinical input with a support medium to generate clinician driven support media, the support medium monitored by the clinician for directing the support media to the patient.

18. The system of claim 17 further comprising an interactive patient interface and an interactive clinician interface, wherein the support medium includes remote multimedia transport and rendering system adapted for individual interfacing by a plurality of clinicians and a plurality of patients, each patient corresponding to at least one of the clinicians.

19. The system of claim 18 wherein the identifier is a URL to a website, the website providing the multimedia rendering medium and the website requests proactive confirmation from the patient, support medium includes social networking mediums configured to identify other patients via the social networking medium, and invoke an interface for feedback exchange via the social networking medium.

20. A computer program product having instructions encoded on a non-transitory computer readable storage medium that, when executed by a processor, perform a method for implementing a compulsive behavior support therapy comprising:
providing an identifier for a smoking cessation resource, the smoking cessation resource invokable via the identifier;
receiving a patient status indicative of a motivation level of the patient;
generating support media based on the received motivation level; and
periodically reassessing the motivation level and modifying the generated support media in response thereto.
